(19) United States
(12) Patent Application Publication
(10) Pub. No.: US 2024/0391020 A1
(43) Pub. Date: Nov. 28, 2024

(54) LASER DEVICE, LASER PROCESSING SYSTEM, AND LASER PROCESSING METHOD

(71) Applicant: Gigaphoton Inc., Tochigi (JP)

(72) Inventors: Takashi ONOSE, Oyama-shi (JP); Yasuhiro KAMBA, Oyama-shi (JP); Hironori IGARASHI, Oyama-shi (JP)

(73) Assignee: Gigaphoton Inc., Tochigi (JP)

(21) Appl. No.: 18/796,336

(22) Filed: Aug. 7, 2024

Related U.S. Application Data
(63) Continuation of application No. PCT/JP2022/010729, filed on Mar. 10, 2022.

(51) Int. Cl. B23K 26/0622; B23K 26/06; B23K 26/064; B23K 26/70

(52) U.S. Cl. CPC B23K 26/0624; B23K 26/0604; B23K 26/064; B23K 26/702

(57) ABSTRACT

A laser device, to be used in a laser processing system for performing laser processing by irradiating a workpiece with laser light in a gas containing oxygen includes a solid-state oscillator including a solid-state laser device configured to output laser light having a pulse width in a range of 100 ps to 1 ns both inclusive and having a center wavelength within an oscillation wavelength range of an ArF excimer laser device and outside absorption lines of oxygen, an ArF excimer amplifier configured to amplify the laser light output from the solid-state oscillator, and a first optical pulse stretcher configured to output laser light that is burst-pulsed by dividing the laser light amplified by the ArF excimer amplifier into a plurality of pulses as the laser light being caused to circulate through a delay optical path thereof.

### CROSS-REFERENCE TO RELATED APPLICATIONS

The present application claims the benefit of International Application No. PCT/JP2022/010729, filed on Mar. 10, 2022, the entire contents of which are hereby incorporated by reference.

### BACKGROUND

### 1. Technical Field

The present disclosure relates to a laser device, a laser processing system, and a laser processing method.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser device for exposure, a KrF excimer laser device for outputting laser light having a wavelength of about 248.0 nm and an ArF excimer laser device for outputting laser light having a wavelength of about 193.4 nm are used.

The KrF excimer laser device and the ArF excimer laser device each have a large spectral line width of about 350 μm to 400 μm in natural oscillation light. Therefore, when a projection lens is formed of a material that transmits ultraviolet rays such as KrF laser light and ArF laser light, there is a case in which chromatic aberration occurs. As a result, the resolution may decrease. Then, a spectral line width of laser light output from the gas laser device needs to be narrowed to the extent that the chromatic aberration can be ignored. For this purpose, there is a case in which a line narrowing module (LNM) including a line narrowing element (etalon, grating, and the like) is provided in a laser resonator of the gas laser device to narrow a spectral line width. In the following, a gas laser device with a narrowed spectral line width is referred to as a line narrowing gas laser device.

### LIST OF DOCUMENTS

### Patent Documents

Patent Document 1: US Patent Application No. 2018/0057390
Patent Document 2: US Patent Application No. 2019/0245321
Patent Document 3: International Publication No. WO2021/024436
Patent Document 4: Japanese Patent Application No. H3-157917
Patent Document 5: Japanese Patent Application No. 2010-145038
Patent Document 6: International Publication No. WO2018/100638

### SUMMARY

A laser device according to an aspect of the present disclosure, to be used in a laser processing system for performing laser processing by irradiating a workpiece with laser light in a gas containing oxygen, includes a solid-state oscillator including a solid-state laser device configured to output laser light having a pulse width in a range of 100 ps to 1 ns both inclusive and having a center wavelength within an oscillation wavelength range of an ArF excimer laser device and outside absorption lines of oxygen, an ArF excimer amplifier configured to amplify the laser light output from the solid-state oscillator, and a first optical pulse stretcher configured to output laser light that is burst-pulsed by dividing the laser light amplified by the ArF excimer amplifier into a plurality of pulses as the laser light being caused to circulate through a delay optical path thereof.

A laser processing system, according to an aspect of the present disclosure, for performing laser processing by irradiating a workpiece with laser light in a gas containing oxygen, includes a laser device, and an optical device configured to irradiate the workpiece with burst-pulsed laser light output from the laser device. Here, the laser device includes a solid-state oscillator including a solid-state laser device configured to output laser light having a pulse width in a range of 100 ps to 1 ns both inclusive and having a center wavelength within an oscillation wavelength range of an ArF excimer laser device and outside absorption lines of oxygen, an ArF excimer amplifier configured to amplify the laser light output from the solid-state oscillator, and a first optical pulse stretcher configured to output laser light that is burst-pulsed by dividing the laser light amplified by the ArF excimer amplifier into a plurality of pulses as the laser light being caused to circulate through a delay optical path thereof.

A laser processing method according to an aspect of the present disclosure, for performing laser processing by irradiating a workpiece with laser light in a gas containing oxygen, includes performing laser processing by irradiating the workpiece with burst-pulsed laser light generated by a laser device. Here, the laser device includes a solid-state oscillator including a solid-state laser device configured to output laser light having a pulse width in a range of 100 ps to 1 ns both inclusive and having a center wavelength within an oscillation wavelength range of an ArF excimer laser device and outside absorption lines of oxygen, an ArF excimer amplifier configured to amplify the laser light output from the solid-state oscillator, and a first optical pulse stretcher configured to output laser light that is burst-pulsed by dividing the laser light amplified by the ArF excimer amplifier into a plurality of pulses as the laser light being caused to circulate through a delay optical path thereof.

### BRIEF DESCRIPTION OF THE DRAWINGS

Embodiments of the present disclosure will be described below merely as examples with reference to the accompanying drawings.

FIG. 1 is a view schematically showing the configuration of a laser processing system according to a comparative example.

FIG. 2 is a view schematically showing the configuration of a laser device according to the comparative example.

FIG. 3 is a graph showing an example of a pulse waveform of laser light output from the laser device.

FIG. 4 is a graph showing spectral waveforms of ArF excimer laser light.

FIG. 5 is a graph showing the relationship between the repetition frequency of the laser light output from the laser device according to the comparative example and the power of the laser light at an irradiation receiving surface.

FIG. 6 is a view schematically showing the configuration of the laser device according to a first embodiment.

FIG. 7 is an explanatory diagram of burst-pulsing with a third OPS.

FIG. 8 is a graph showing an example of a waveform of burst-pulsed laser light output from the laser device according to the first embodiment.

FIG. 9 is a graph showing the relationship between the repetition frequency of the laser light output from the laser device according to the first embodiment and the power of the laser light at the irradiation receiving surface.

FIG. 10 is a graph showing absorption spectra of ozone and oxygen.

FIG. 11 is a diagram schematically showing the light intensity of a single pulse.

FIG. 12 is a diagram schematically showing burst-pulses generated by dividing the single pulse shown in FIG. 11.

FIG. 13 is a sectional photograph showing a result of drilling performed by the laser processing system according to the first embodiment.

FIG. 14 is a graph showing the relationship between the number of pulses and processing depth shown in FIG. 13.

FIG. 15 is a graph showing the relationship between a fluence and an ablation rate.

FIG. 16 is a block diagram schematically showing the configuration of a solid-state laser device according to the first embodiment.

FIG. 17 is a block diagram schematically showing the configuration of the solid-state laser device according to a modification of the first embodiment.

FIG. 18 is a block diagram schematically showing the configuration of the laser device according to a second embodiment.

FIG. 19 is a graph showing an example of a waveform of burst-pulsed laser light output from the laser device according to the second embodiment.

FIG. 20 is a sectional photograph showing a result of drilling performed by the laser processing system according to the second embodiment.

FIG. 21 shows a result of drilling performed by the laser processing system according to the first embodiment.

FIG. 22 is a graph showing an example of a waveform of single pulse laser light output from the laser device according to the comparative example.

FIG. 23 is a sectional photograph showing a result of drilling performed by the laser processing system according to the comparative example.

FIG. 24 is a sectional photograph showing a result of drilling performed by the laser processing system according to the second embodiment.

FIG. 25 is a block diagram schematically showing the configuration of the laser device according to a third embodiment.

FIG. 26 is a block diagram schematically showing the configuration of the laser device according to a fourth embodiment.

FIG. 27 is a graph showing an example of a waveform of burst-pulsed laser light output from the laser device according to the fourth embodiment.

FIG. 28 is a block diagram schematically showing the configuration of the solid-state laser device according to a first modification.

FIG. 29 is a block diagram schematically showing the configuration of the solid-state laser device according to a second modification.

### DESCRIPTION OF EMBODIMENTS

### Contents

1. Comparative example
   1.1 Laser processing system
      1.1.1 Configuration
      1.1.2 Operation
   1.2 Laser device
      1.2.1 Configuration
      1.2.2 Operation
   1.3 Problem
2. First embodiment
   2.1 Configuration
   2.2 Operation
   2.3 Effect
   2.4 Solid-state laser device
      2.4.1 Configuration and operation
   2.5 Modification of solid-state laser device
      2.5.1 Configuration and operation
3. Second embodiment
   3.1 Configuration and operation
   3.2 Effect
4. Third embodiment
   4.1 Configuration and operation
5. Fourth embodiment
   5.1 Configuration and operation
   5.2 Effect
6. Modification of solid-state laser device
   6.1 First modification
      6.1.1 Configuration and operation
      6.1.2 Effect
   6.2 Second modification
      6.2.1 Configuration and operation
      6.2.2 Effect

Hereinafter, embodiments of the present disclosure will be described in detail with reference to the drawings. The embodiments described below show some examples of the present disclosure and do not limit the contents of the present disclosure. Also, all configurations and operation described in the embodiments are not necessarily essential as configurations and operation of the present disclosure. Here, the same components are denoted by the same reference numeral, and duplicate description thereof is omitted.

### 1. Comparative Example

### 1.1 Laser Processing System

### 1.1.1 Configuration

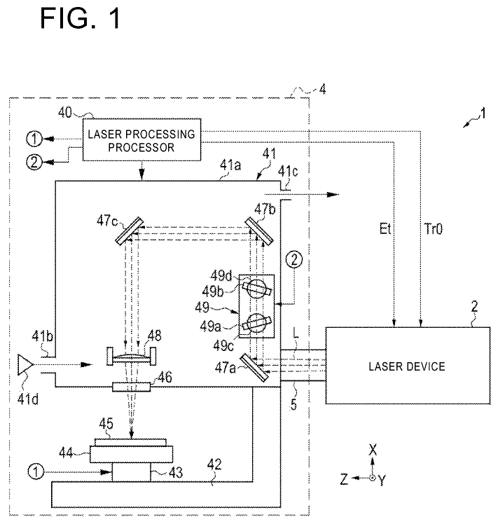

FIG. 1 schematically shows the configuration of a laser processing system 1 according to a comparative example. The comparative example is an example recognized by the applicant as known only by the applicant, and is not a publicly known example admitted by the applicant.

The laser processing system 1 includes a laser device 2 and a laser processing apparatus main body 4 as a main configuration. The laser device 2 and the laser processing apparatus main body 4 are connected by an optical pipe 5. The laser processing system 1 is used, for example, for drilling a glass substrate for an interposer.

The laser processing apparatus main body 4 includes a laser processing processor 40, an optical device 41, a frame 42, a moving stage 43, and a table 44. The optical device 41 and the moving stage 43 are fixed to the frame 42.

The table 44 supports a workpiece 45. The workpiece 45 is a processing target to which laser processing is performed by being irradiated with laser light L. The workpiece 45 is a substrate transparent to the ultraviolet laser light L, for example, an Eagle glass substrate or a quartz glass substrate.

The moving stage 43 supports the table 44. The moving stage 43 is movable in an X direction, a Y direction, and a Z direction, and the position of the workpiece 45 can be adjusted by adjusting the position of the table 44. Under control of the laser processing processor 40, the moving stage 43 adjusts the position of the workpiece 45 so that the laser light L output from the optical device 41 is radiated to a desired processing position.

The optical device 41 includes a housing 41a, high reflection mirrors 47a, 47b, 47c, an attenuator 49, a light concentrating optical system 48, and a window 46, and transfers an image corresponding to a processing shape to the surface of the workpiece 45. Each of the light concentrating optical system 48 and the high reflection mirrors 47a, 47b, 47c is fixed to a holder, and is arranged at a predetermined position in the housing 41a.

A nitrogen (N₂) gas, which is an inert gas, constantly flows inside the housing 41a during operation of the laser processing system 1. The housing 41a is provided with a suction port 41b for sucking the nitrogen gas into the housing 41a, and an exhaust port 41c for exhausting the nitrogen gas from the housing 41a to the outside. A suction pipe (not shown), an exhaust pipe (not shown), and the like can be connected to the suction port 41b and the exhaust port 41c, respectively. A nitrogen gas supply source 41d is connected to the suction port 41b.

The high reflection mirrors 47a, 47b, 47c reflect the laser light L output from the laser device 2 at a high reflectance. The high reflection mirror 47a reflects the laser light L output from the laser device 2 toward the high reflection mirror 47b. The high reflection mirror 47b reflects the laser light L toward the high reflection mirror 47c. The high reflection mirror 47c reflects the laser light L toward the light concentrating optical system 48. Each of the high reflection mirrors 47a, 47b, 47c is a transparent substrate formed of, for example, synthetic quartz or calcium fluoride, and the surface thereof is coated with a reflection film that highly reflects the laser light L.

The light concentrating optical system 48 concentrates the laser light L having entered and outputs the laser light L toward the workpiece 45 through the window 46. Specifically, the light concentrating optical system 48 is arranged such that the beam waist position of the concentrated laser light L is in the workpiece 45 and can be concentrated at a predetermined depth ΔZsfw from the surface of the workpiece 45 on the incident side. The light concentrating optical system 48 may be a single lens or a group lens subjected to aberration correction.

The window 46 is arranged on the optical path between the light concentrating optical system 48 and the workpiece 45, and is fixed to an opening formed in the housing 41a in a state of being sealed with an O-ring (not shown). There is air between the window 46 and the workpiece 45.

The attenuator 49 is arranged on the optical path between the high reflection mirror 47a and the high reflection mirror 47b in the housing 41a. The attenuator 49 includes, for example, two partial reflection mirrors 49a, 49b and rotation stages 49c, 49d for the partial reflection mirrors 49a, 49b. The partial reflection mirrors 49a, 49b are optical elements whose transmittance varies depending on the incident angle of the laser light L. The inclination angles of the partial reflection mirrors 49a, 49b are adjusted by the rotation stages 49c, 49d so that the incident angles of the laser light L thereon coincide with each other and a desired transmittance is obtained.

### 1.1.2 Operation

Next, operation of the laser processing system 1 will be described. When laser processing is to be performed, the workpiece 45 is set on the table 44 of the moving stage 43. The laser processing processor 40 sets position data of an initial processing position in the moving stage 43.

The moving stage 43 moves the workpiece 45 to an initial laser processing position. Specifically, the workpiece 45 is positioned in the YZ plane and in the X direction. With respect to the position in the X direction, the laser processing processor 40 moves the workpiece 45 so that the beam waist position of the laser light L output from the light concentrating optical system 48 becomes the position at a depth ΔZsfw from the surface of the workpiece 45. The laser light L is concentrated with a predetermined radiation diameter Dw at the beam waist position.

Next, the laser processing processor 40 transmits a target pulse energy Et to the laser device 2 and controls a transmittance T of the attenuator 49 such that the laser light L radiated to the workpiece 45 has a target fluence Fm. Specifically, the laser processing processor 40 controls the energy entering the workpiece 45 under the control of the target pulse energy Et and the transmittance T of the attenuator 49.

Here, the target fluence Fm is the fluence required for laser processing, and is the radiation energy density of the laser light L at the beam waist position. When the optical loss of optical elements of the optical device 41 other than the attenuator 49 is negligible, the target fluence Fm is defined by the following expression (1).

$$\begin{matrix}[ Expression 1 ] & \\ F m = \frac{Et \cdot T}{{π ( \frac{D w}{2} )}^{2}} & ( 1 )\end{matrix}$$

In this case, the transmittance T of the attenuator 49 is determined by the following expression (2) obtained by deforming the above expression (1).

$$\begin{matrix}[ Expression 2 ] & \\ T = {π ( \frac{D w}{2} )}^{2} \cdot ( \frac{F m}{E t} ) & ( 2 )\end{matrix}$$

After setting the transmittance T of the attenuator 49, the laser processing processor 40 transmits a light emission trigger signal Tr0 defined by the repetition frequency and the number of pulses to the laser device 2. As a result, the laser light L is output from the laser device 2 to the laser processing apparatus main body 4 in synchronization with the light emission trigger signal Tr0.

The laser light L having entered the laser processing apparatus main body 4 enters the attenuator 49 via the high reflection mirror 47a, and is attenuated by the attenuator 49. The laser light L transmitted through the attenuator 49 is reflected by the high reflection mirror 47b and is incident on the high reflection mirror 47c. The laser light L reflected by the high reflection mirror 47c enters the light concentrating optical system 48.

The laser light L transmitted through the light concentrating optical system 48 is concentrated, through the window 46, at a position in the workpiece 45 and at the predetermined depth ΔZsfw from the surface of the workpiece 45 on the incident side. As a result, the laser light L is radiated with a predetermined fluence, repetition frequency, and number of pulses at the depth ΔZsfw of the workpiece 45, and the workpiece 45 is drilled with the laser light L.

In the present disclosure, although the reflectance or the transmittance of each of the high reflection mirrors 47a, 47b, 47c, the light concentrating optical system 48, and the window 46 is assumed to be 100%, the reflectance or the transmittance thereof is not limited to 100%. For example, a transmittance T0 of the optical devices described above in total may be determined in advance, and the transmittance T of the attenuator 49 may be determined based on the following expression (3).

$$\begin{matrix}[ Expression 3 ] & \\ T = {π ( \frac{D w}{2} )}^{2} \cdot ( \frac{F m}{Et \cdot T 0} ) & ( 3 )\end{matrix}$$

### 1.2 Laser Device

### 1.2.1 Configuration

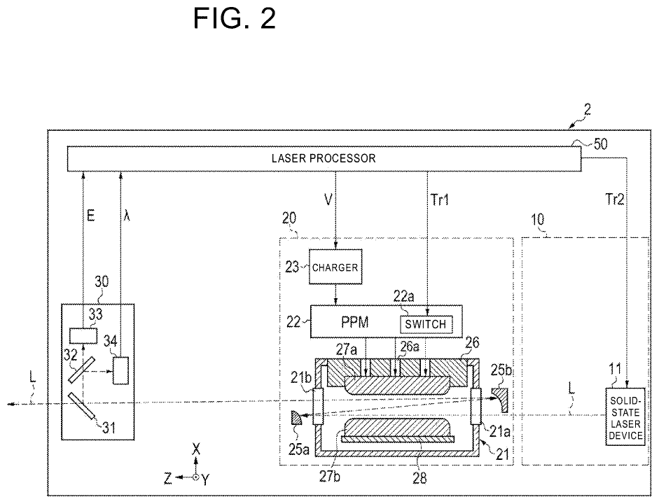

FIG. 2 schematically shows the configuration of the laser device 2 according to the comparative example. The laser device 2 includes a solid-state oscillator 10, an ArF excimer amplifier 20, a monitor module 30, and a laser processor 50.

The solid-state oscillator 10 includes a solid-state laser device 11 that outputs pulse laser light L having a center wavelength in an oscillation wavelength range of a general ArF excimer laser device. The oscillation wavelength range of an ArF excimer laser device is, for example, a wavelength range of 193.0 nm or more and 193.9 nm or less.

The ArF excimer amplifier 20 is an excimer laser device using a mixed gas including argon (Ar), fluorine (F₂), and neon (Ne) as a laser medium.

The ArF excimer amplifier 20 includes a laser chamber 21, a pulse power module (PPM) 22, a charger 23, a convex mirror 25a, and a concave mirror 25b. The laser chamber 21 is provided with windows 21a, 21b. A laser gas as a laser medium is enclosed in the laser chamber 21.

Further, an opening is formed in the laser chamber 21, and an electrically insulating plate 26 in which a plurality of feedthroughs 26a are embedded is provided so as to block the opening. The PPM 22 is arranged on the electrically insulating plate 26. A pair of discharge electrodes 27a, 27b as main electrodes and a ground plate 28 are arranged in the laser chamber 21.

The discharge electrodes 27a, 27b are arranged such that discharge surfaces of the both face each other to excite the laser medium by discharge. The space between the discharge surface of the discharge electrode 27a and the discharge surface of the discharge electrode 27b is referred to as a discharge space. The discharge electrode 27a is supported by the electrically insulating plate 26 on a surface opposite to the discharge surface thereof. The discharge electrode 27a is connected to the feedthroughs 26a. The discharge electrode 27b is supported by the ground plate 28 on a surface opposite to the discharge surface thereof.

The PPM 22 includes a switch 22a, a charging capacitor (not shown), a pulse transformer (not shown), a magnetic compression circuit (not shown), and a peaking capacitor (not shown). The peaking capacitor is connected to the feedthroughs 26a via a connection portion (not shown). The charger 23 charges the charging capacitor. Specifically, the charger 23 charges the charging capacitor based on a set value of a charge voltage V input from the laser processor 50.

The switch 22a is controlled to be turned on/off by a first internal trigger signal Tr1 described later. When the switch 22a is turned on, a current flows from the charging capacitor to the primary side of the pulse transformer, and a current in a reverse direction flows in the secondary side of the pulse transformer by electromagnetic induction. The magnetic compression circuit is connected to the secondary side of the pulse transformer and compresses the pulse width of current pulses. The peaking capacitor is charged by the current pulses. When the voltage of the peaking capacitor reaches a breakdown voltage of the laser gas, breakdown occurs at the laser gas between the discharge electrodes 27a, 27b to cause discharge.

The convex mirror 25a and the concave mirror 25b are arranged such that the laser light L output from the solid-state oscillator 10 passes through the discharge space between the discharge electrodes 27a, 27b three times and the beam width thereof is expanded. That is, the ArF excimer amplifier 20 is a multipass amplifier.

The laser light L output from the solid-state oscillator 10 is transmitted through the window 21a, passes through the discharge space, is transmitted through the window 21b, and is reflected by the convex mirror 25a. The laser light L reflected by the convex mirror 25a is transmitted through the window 21b, passes through the discharge space, is transmitted through the window 21a, and is reflected by the concave mirror 25b. The laser light L reflected by the concave mirror 25b is transmitted through the window 21a, passes through the discharge space, is transmitted through the window 21b, and is output to the outside of the ArF excimer amplifier 20. The beam width of the laser light L is expanded in the X direction when the laser light Lis reflected by the convex mirror 25a.

The laser processor 50 generates the first internal trigger signal Tr1 and a second internal trigger signal Tr2. The laser processor 50 inputs the first internal trigger signal Tr1 to the ArF excimer amplifier 20, and inputs the second internal trigger signal Tr2 to the solid-state oscillator 10. A predetermined time difference is provided between the first internal trigger signal Tr1 and the second internal trigger signal Tr2 so that discharge occurs when the laser light L output from the solid-state oscillator 10 enters the discharge space of the ArF excimer amplifier 20.

The laser light L having entered the discharge space of the ArF excimer amplifier 20 is amplified by the discharge occurring in the discharge space, and is output from the ArF excimer amplifier 20. The monitor module 30 is arranged on the optical path of the laser light L output from the ArF excimer amplifier 20. In the laser device 2, the optical path of the laser light L at any position other than the laser chamber 21 is sealed by a housing (not shown) or an optical path pipe (not shown) and purged with an N₂ gas.

The monitor module 30 includes a first beam splitter 31, a second beam splitter 32, an energy sensor 33, and a wavelength monitor 34. The first beam splitter 31 is arranged on the optical path of the laser light L and reflects a part of the laser light L. The second beam splitter 32 is arranged on the optical path of the reflection light reflected by the first beam splitter 31, and reflects a part of the reflection light.

The transmission light transmitted through the second beam splitter 32 enters the energy sensor 33. The energy sensor 33 includes, for example, a photodiode sensitive to ultraviolet light, and detects the energy of the entering light. That is, the energy sensor 33 measures a pulse energy E of the laser light L. The energy sensor 33 transmits the measurement value of the pulse energy E to the laser processor 50.

The reflection light reflected by the second beam splitter 32 enters the wavelength monitor 34. The wavelength monitor 34 includes an etalon spectrometer configured of a diffusion plate (not shown), an air gap etalon (not shown), a light concentrating lens (not shown), and a line sensor (not shown). By detecting, by the line sensor, the radius of interference fringes generated by the diffusion plate, the air gap etalon, and the light concentrating lens, a wavelength λ of the laser light L is measured. The wavelength monitor 34 transmits the measurement value of the wavelength λ to the laser processor 50.

### 1.2.2 Operation

Next, operation of the laser device 2 will be described. Upon receiving the light emission trigger signal Tr0 from the laser processing processor 40, the laser processor 50 generates the first internal trigger signal Tr1, and generates the second internal trigger signal Tr2 after a trigger delay time elapses from the generation of the first internal trigger signal Tr1. The laser processor 50 inputs the first internal trigger signal Tr1 to the ArF excimer amplifier 20, and inputs the second internal trigger signal Tr2 to the solid-state oscillator 10.

When the second internal trigger signal Tr2 is input to the solid-state oscillator 10, the laser light L is output from the solid-state laser device 11.

When the first internal trigger signal Tr1 is input to the ArF excimer amplifier 20, the charge voltage V output from the charger 23 is converted into a high voltage pulse at the PPM 22 and is applied to the discharge electrodes 27a, 27b. When discharge occurs in the discharge space, the laser gas is excited. At this timing, the laser light L enters the laser chamber 21 from the solid-state oscillator 10. The laser light Lis amplified by the discharge, and the beam width thereof is expanded while the laser light L is reflected between the convex mirror 25a and the concave mirror 25b. The laser light L amplified in the discharge space and expanded in beam width is output from the ArF excimer amplifier 20.

The laser light L output from the ArF excimer amplifier 20 enters the monitor module 30. A part of the laser light L having entered the monitor module 30 is sampled by the first beam splitter 31, so that the pulse energy E and the wavelength λ thereof are measured. The measurement value of the pulse energy E and the measurement value of the wavelength λ are output to the laser processor 50.

The laser processor 50 compares the measurement value of the wavelength λ with a target wavelength λt, and controls the solid-state oscillator 10 so that the measurement value approaches the target wavelength λt. Further, the laser processor 50 compares the measurement value of the pulse energy E with the target pulse energy Et, and controls the ArF excimer amplifier 20 so that the measurement value approaches the target pulse energy Et.

The laser light L having passed through the monitor module 30 is output to the laser processing apparatus main body 4. The laser processing apparatus main body 4 performs laser processing on the workpiece 45 by using the laser light L output from the laser device 2.

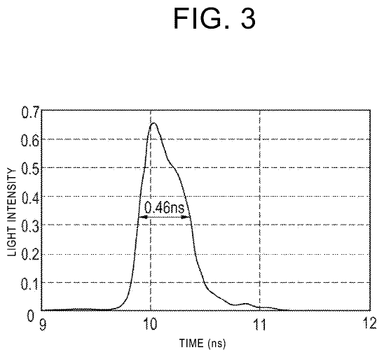

FIG. 3 shows an example of a pulse waveform of the laser light L output from the laser device 2. The pulse width of the laser light L is in a range of 100 ps to 1 ns both inclusive. In the example shown in FIG. 3, the pulse width of the pulse waveform of the laser light Lis about 0.46 ns. Here, the pulse width is represented as full width at half maximum, and represents the time width of a portion at which the light intensity is 50% of the peak value. In the comparative example, the pulse waveform of the laser light L output from the solid-state laser device 11 is similar to the pulse waveform of the laser light L output from the laser device 2 except that the light intensity is different.

### 1.3 Problem

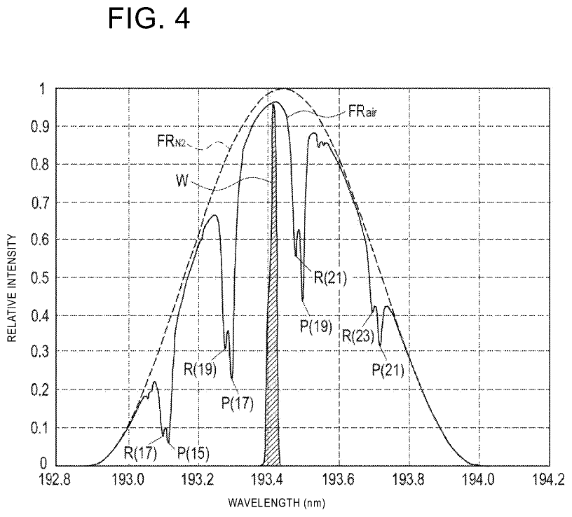

FIG. 4 shows spectral waveforms of ArF excimer laser light output when an ArF excimer laser device is spontaneously oscillated (free running) without performing line narrowing. FRₐᵢᵣ represents a spectral waveform of the ArF excimer laser light in a gas containing oxygen, for example, in air. FR_{N2} represents a spectral waveform of the ArF excimer laser light in an oxygen-free nitrogen gas.

The spectral waveform FR_{N2} has a center wavelength of about 193.4 nm and a spectral linewidth of about 500 pm at full width at half maximum. It is known that oxygen has a plurality of absorption lines that are absorption bands to absorb laser light. Since the wavelength range of the ArF excimer laser light overlaps with a plurality of absorption lines of oxygen, a plurality of absorption lines exist in the spectral waveform FRₐᵢᵣ. Here, the vertical axis in FIG. 4 represents the relative intensity obtained by normalizing the light intensity.

Absorption by oxygen shown in FIG. 4 is caused by absorption transitions in the Schumann-Runge band. Oxygen has an oscillation band in the vicinity of a wavelength of 193 nm and has absorption characteristics represented by branches R(17), P(15), R(19), P(17), R(21), P(19), R(23), P(21) for respective rotational levels. The spectral waveform FRₐᵢᵣ has a drop in the light intensity at the absorption lines corresponding to the respective branches, as compared with the spectral waveform FR_{N2}.

A waveform W shown in FIG. 4 is an example of a spectral waveform of the laser light L output from the solid-state laser device 11. In order to reduce absorption of the laser light L by oxygen, the solid-state laser device 11 may be caused to oscillate within the oscillation wavelength range of the ArF excimer laser device at a wavelength outside the absorption lines of oxygen. For example, the solid-state laser device 11 is caused to oscillate in a wavelength range between P(15) and R(19), between P(17) and R(21), or between P(19) and R(23).

Specifically, the center wavelength of the laser light L is set to a wavelength included in a wavelength range of 193.113 nm or more and 193.273 nm or less, a wavelength range of 193.292 nm or more and 193.472 nm or less, or a wavelength range of 193.493 nm or more and 193.697 nm or less. Preferably, the center wavelength of the laser light L is set to a wavelength included in a wavelength range of 193.12 nm or more and 193.26 nm or less, a wavelength range of 193.30 nm or more and 193.46 nm or less, or a wavelength range of 193.50 nm or more and 193.68 nm or less. More preferably, the center wavelength of the laser light L is set to 193.4 nm.

However, even with the wavelength outside the absorption lines of oxygen as described above, a following problem arises in the case of laser processing on the workpiece 45 with the laser light L having a short pulse width.

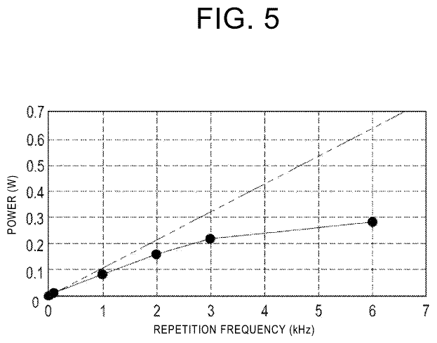

FIG. 5 shows the relationship between the repetition frequency of the laser light L output from the laser device 2 according to the comparative example and the power of the laser light L at an irradiation receiving surface. Here, the repetition frequency corresponds to the number of pulses of the laser light L output by the solid-state laser device 11 in a unit time. The power corresponds to the sum of the pulse energy at the irradiation receiving surface per unit time.

When drilling or the like is performed on the workpiece 45 with the laser light L, it is required to increase the power of the laser light L. In simple consideration, the power of the laser light L is supposed to increase in proportion to the repetition frequency. This is because the number of pulses of the laser light L radiated to the irradiation receiving surface per unit time increases in proportion to the repetition frequency.

However, in the laser device 2 according to the comparative example, it was confirmed that, when the repetition frequency is equal to or higher than 2 kHz, the power of the laser light L does not increase in proportion to the repetition frequency and the increase rate decreases. This means that the pulse energy of the laser light L decreases at the irradiation receiving surface when the repetition frequency increases. Therefore, in order to increase the power of the laser light L, it is required to suppress a decrease in the pulse energy at the irradiation receiving surface accompanied by an increase in the repetition frequency.

### 2. First Embodiment

Next, the laser processing system according to a first embodiment of the present disclosure will be described. Any component same as that described above is denoted by an identical reference sign, and duplicate description thereof is omitted unless specific description is needed.

### 2.1 Configuration

The laser processing system according to the first embodiment includes a laser device 2a and the laser processing apparatus main body 4 as a main configuration. The configuration of the laser processing apparatus main body 4 is similar to that of the comparative example.

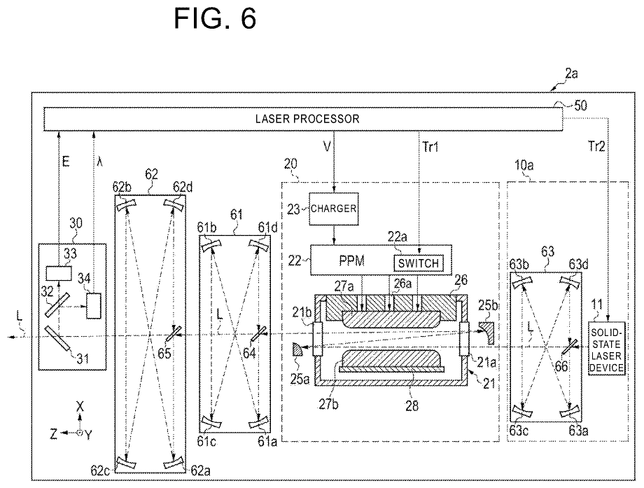

FIG. 6 schematically shows the configuration of the laser device 2a according to the first embodiment. The laser device 2a includes a first optical pulse stretcher (OPS) 61, a second OPS 62, and a third OPS 63 in addition to the configuration of the laser device 2 according to the comparative example.

The first OPS 61 and the second OPS 62 are arranged between the ArF excimer amplifier 20 and the monitor module 30. The configuration of the ArF excimer amplifier 20 is similar to that of the comparative example. The third OPS 63 is arranged in a solid-state oscillator 10a at a stage subsequent to the solid-state laser device 11. The solid-state oscillator 10a according to the present embodiment is different from the solid-state oscillator 10 according to the comparative embodiment in that the third OPS 63 is included in addition to the solid-state laser device 11.

The configuration of the solid-state laser device 11 is similar to that of the comparative example. The solid-state laser device 11 outputs the laser light L having a pulse width in a range of 100 ps to 1 ns both inclusive and having a center wavelength within the oscillation wavelength range of the ArF excimer laser device and outside the absorption lines of oxygen.

Each of the first OPS 61, the second OPS 62, and the third OPS 63 is a delay optical system that transmits a part of the entering laser light L and outputs the other part after causing the other part to circulate through a delay optical path one or more times, thereby dividing one pulse into a plurality of pulses. The delay optical path is configured of a plurality of concave mirrors. The delay time due to the delay optical path is longer than the pulse width of the entering single pulse laser light L.

The third OPS 63 is arranged such that a part of the laser light L output from the solid-state laser device 11 circulates through the delay optical path in the third OPS 63, and that the laser light L output from the third OPS 63 enters the ArF excimer amplifier 20. The third OPS 63 includes a beam splitter 66, a first concave mirror 63a, a second concave mirror 63b, a third concave mirror 63c, and a fourth concave mirror 63d. For example, the reflectance of the beam splitter 66 is in a range of 40% to 70% both inclusive. For example, an optical path length DL3 of the delay optical path of the third OPS 63 is in a range of 0.6 meter to 1.4 meter both inclusive.

The first OPS 61 is arranged such that a part of the laser light L output from the ArF excimer amplifier 20 circulates through the delay optical path in the first OPS 61, and that the laser light L output from the first OPS 61 enters the second OPS 62. The first OPS 61 includes a beam splitter 64, a first concave mirror 61a, a second concave mirror 61b, a third concave mirror 61c, and a fourth concave mirror 61d. For example, the reflectance of the beam splitter 64 is in a range of 40% to 70% both inclusive. For example, an optical path length DL1 of the delay optical path of the first OPS 61 is in a range of 2 meters to 14 meters both inclusive. Specifically, the delay time due to the delay optical path of the first OPS 61 is preferably within a range of 2 times to 500 times both inclusive of the pulse width of the laser light L output from the solid-state laser device 11.

The second OPS 62 is arranged such that a part of the laser light L output from the first OPS 61 circulates through the delay optical path in the second OPS 62, and that the laser light L output from the second OPS 62 enters the monitor module 30. For example, the reflectance of the beam splitter 65 is in a range of 40% to 70% both inclusive. For example, an optical path length DL2 of the delay optical path of the second OPS 62 is in a range of 1.5 times to 3 times both inclusive of the optical path length DL1.

In the present embodiment, the optical path lengths of the delay optical paths of the first OPS 61, the second OPS 62, and the third OPS 63 are determined so as to satisfy the relationship of DL3<DL1<DL2.

### 2.2 Operation

Next, operation of the laser device 2a will be described. Hereinafter, only differences from the operation of the laser device 2 according to the comparative example will be described.

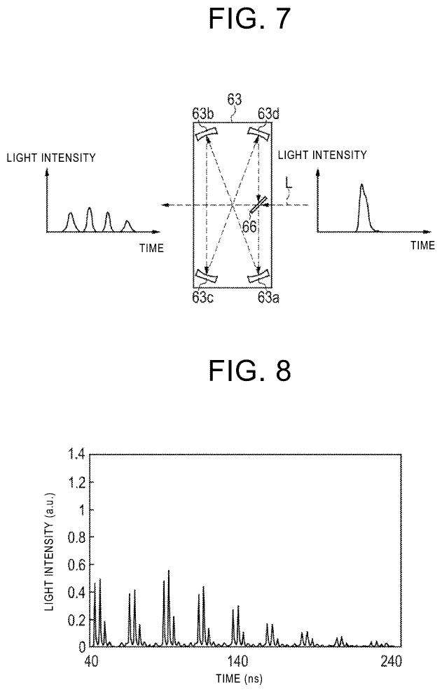

The laser light L output from the solid-state laser device 11 enters the third OPS 63. As shown in FIG. 7, a part of the laser light L having entered the third OPS 63 is output as it is, and the other part thereof is output after circulating through the delay optical path one or more times, thereby dividing the laser light L into a plurality of pulses. For example, when the optical path length DL3 is 0.6 m, the pulse of the laser light L is delayed by about 1.8 ns for each circulation. Since the pulse width of the laser light L output from the solid-state laser device 11 is equal to or less than 1 ns, pulses having different number of circulations of the delay optical path do not temporally overlap each other. Generating a plurality of pulses that do not temporally overlap from one pulse in this way is referred to as burst-pulsing.

The laser light L burst-pulsed by the third OPS 63 is amplified by the ArF excimer amplifier 20. The laser light L output from the ArF excimer amplifier 20 is further divided by circulating through the delay optical path of the first OPS 61 and the delay optical path of the second OPS 62.

The laser light L output from the laser device 2a is burst-pulsed as shown in FIG. 8 and output to the laser processing apparatus main body 4. In FIG. 8, tails between adjacent pulses appear to overlap, but this is because the time resolution of a measurement device is not sufficient.

### 2.3 Effect

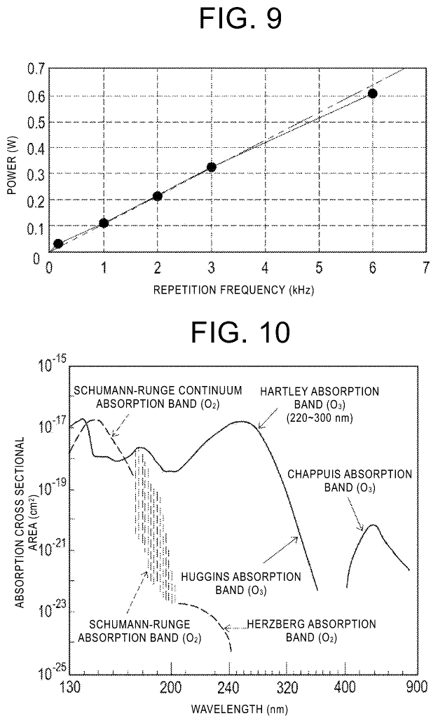

FIG. 9 shows the relationship between the repetition frequency of the laser light L output from the laser device 2a according to the first embodiment and the power of the laser light L at the irradiation receiving surface. As shown in FIG. 9, when the burst-pulsed laser light L was used, the power of the laser light L increased in proportion to the repetition frequency up to 6 kHz. That is, a decrease in the pulse energy at the irradiation receiving surface was suppressed up to the repetition frequency of 6 kHz. It is presumed that this effect was obtained for the following reasons.

Even when the laser light L has a center wavelength outside the absorption lines of oxygen, the single pulse laser light L as in the comparative example has a high peak intensity, and thus ozone (O₃) is generated by two-photon absorption in the gas containing oxygen.

When a decomposition reaction rate of ozone is slower than the cycle, which is the reciprocal of the repetition frequency of the laser light L output from the laser device 2, generated ozone remains in the optical path. Ozone generation reaction is represented by the following expressions (4) and (5). Decomposition reaction of ozone is represented by the following expression (6). Here, ozone remaining in the optical path is also reduced by diffusion.

$$\begin{matrix}[ Expression 4 ] & \\ {O}_{2} + 2 hv \to 2 O & ( 4 )\end{matrix}$$

$$\begin{matrix}[ Expression 5 ] & \\ O + {O}_{2} \to {O}_{3} & ( 5 )\end{matrix}$$

$$\begin{matrix}[ Expression 6 ] & \\ {O}_{3} \to {O}_{2} + O & ( 6 )\end{matrix}$$

FIG. 10 shows absorption spectra of ozone and oxygen. It can be understood from FIG. 10 that an absorption cross-sectional area of ozone is higher than that of oxygen by one digit or more at a wavelength of 193 nm. Therefore, when the repetition frequency is high, it is presumed that a large amount of ozone remains in the optical path and the remaining ozone absorbs the laser light L, thereby reducing the pulse energy.

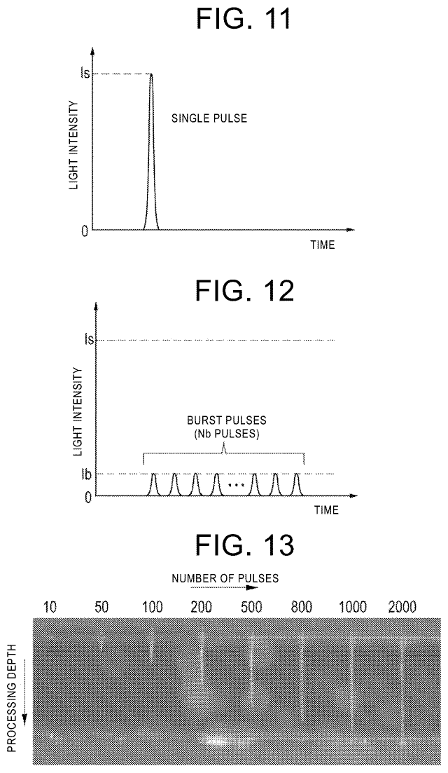

FIG. 11 schematically shows the light intensity of a single pulse. The light intensity of the single pulse shown in FIG. 11 is represented by Is. FIG. 12 schematically shows burst pulses generated by dividing the single pulse shown in FIG. 11 into Nb pulses. It is assumed that the light intensity of pulses included in the burst pulses are equal to each other, and the light intensity of each pulse is Ib. In this case, the ratio Ib/Is of the light intensities is expressed by the following expression (7).

$$\begin{matrix}[ Expression 7 ] & \\ \frac{Ib}{Is} = \frac{1}{N b} & ( 7 )\end{matrix}$$

In general, the transition probability in two-photon absorption is proportional to the square of the light intensity. Therefore, a ratio R of a generation amount of ozone in the case of the burst pulses shown in FIG. 12 with respect to a generation amount of ozone in the case of the single pulse shown in FIG. 11 is approximately expressed by the following expression (8).

$$\begin{matrix}[ Expression 8 ] & \\ R \approx {( \frac{Ib}{Is} )}^{2} \cdot Nb = {( \frac{1}{N b} )}^{2} \cdot Nb = \frac{1}{N b} & ( 8 )\end{matrix}$$

According to the above expression (8), it can be understood that the generation amount of ozone is reduced by dividing the single pulse into the burst pulses. Specifically, it can be understood that the generation amount of ozone decreases in inverse proportion to the number of pulses Nb included in the burst pulses.

In the laser device 2a according to the first embodiment, since the laser light L output from the solid-state laser device 11 is burst-pulsed using the first OPS 61, the second OPS 62, and the third OPS 63, the generation amount of ozone is reduced. As a result, it is presumed that the absorption amount of the laser light L by ozone is reduced, and thus the above-described effect is obtained.

FIG. 13 shows a result of drilling performed by the laser processing system according to the first embodiment. In the present experiment, an Eagle glass substrate was used as the workpiece 45, and the target fluence Fm was set to 11 J/cm². Further, the number of pulses of the laser light L output from the solid-state laser device 11 was changed in a range of 10 to 2000, and the processing depth which is the depth of a processed hole was measured.

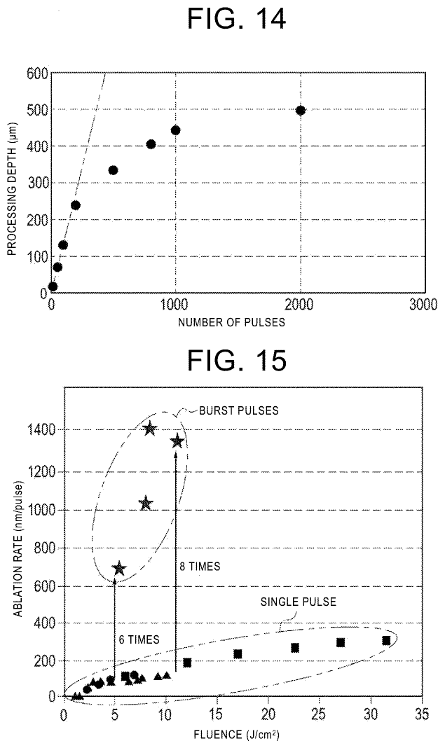

FIG. 14 shows the relationship between the number of pulses and the processing depth shown in FIG. 13. According to FIG. 14, it can be understood that the workpiece 45 is processed at a processing rate of 1350 nm/pulse at the beginning of the processing. The processing rate corresponds to an ablation rate described later.

FIG. 15 shows the relationship between the fluence and the ablation rate. FIG. 15 shows a result of drilling a hole with a depth of 20 μm by the burst-pulsed laser light L according to the present embodiment, and a result of drilling a hole with a depth of 20 μm by the single pulse laser light L according to the comparative example. The workpiece 45 is an Eagle glass substrate. Here, the repetition frequency in the case of the burst pulses is 1 kHz, and the repetition frequency in the case of the single pulse is 100 Hz.

According to FIG. 15, when the fluence is 11 J/cm², it can be understood that the ablation rate (1350 nm/pulse) with the burst pulses is about 8 times the ablation rate with the single pulse. Further, when the fluence is 5 J/cm², the ablation rate with the burst pulses is about 6 times the ablation rate with the single pulse.

When processing is performed with the single pulse, after a product generated by radiation of a pulse is re-fixed, the re-fixed product is processed with the next pulse. On the other hand, when processing is performed with the burst pulses, the next pulse is radiated before a product generated by radiation of a pulse is re-fixed. Therefore, it is considered that the ablation rate increases with the burst pulses. The same effect is expected even when a quartz glass substrate is used as the workpiece 45.

By performing drilling using the burst-pulsed laser light L as described above, since the ablation rate is increased, a threshold value at which damage such as cracks occur is increased, and the processing quality is improved.

### 2.4 Solid-State Laser Device

### 2.4.1 Configuration and Operation

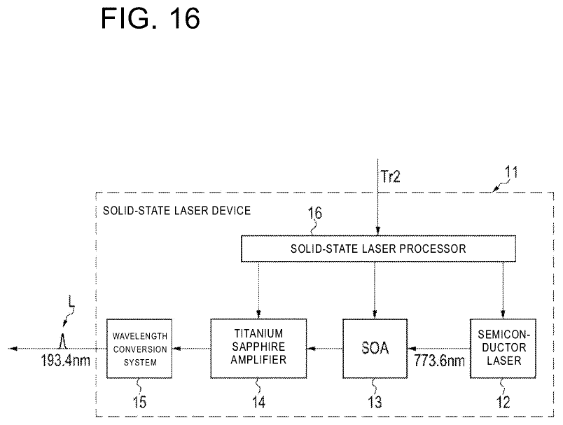

FIG. 16 schematically shows the configuration of the solid-state laser device 11 according to the first embodiment. The solid-state laser device 11 includes a semiconductor laser 12, a semiconductor optical amplifier (SOA) 13, a titanium sapphire amplifier 14, a wavelength conversion system 15, and a solid-state laser processor 16.

Upon receiving the second internal trigger signal Tr2 from the laser processor 50, the solid-state laser processor 16 outputs a trigger signal to the semiconductor laser 12. Upon receiving the trigger signal from the solid-state laser processor 16, the semiconductor laser 12 outputs continuously oscillating laser light having a wavelength in the vicinity of 773.6 nm.

Upon receiving a control signal from the solid-state laser processor 16, the SOA 13 amplifies the laser light output from the semiconductor laser 12 only for a predetermined period of time, thereby outputting laser light having a predetermined pulse width. The pulse width of the laser light output from the SOA 13 is in a range of 100 ps to 1 ns both inclusive. The titanium sapphire amplifier 14 amplifies the laser light output from the SOA 13 and outputs the amplified laser light based on a control signal from the solid-state laser processor 16. The titanium sapphire amplifier 14 is configured of, for example, a titanium sapphire crystal and a pumping pulse laser.

The wavelength conversion system 15 performs wavelength conversion on the laser light output from the titanium sapphire amplifier 14. Specifically, the wavelength conversion system 15 converts the laser light having a wavelength of 773.6 nm output from the titanium sapphire amplifier 14 into laser light having a wavelength of 193.4 nm which is the fourth harmonic. The wavelength conversion system 15 is configured including, for example, an LBO crystal and a KBBF crystal. The laser light wavelength-converted by the wavelength conversion system 15 is output from the solid-state laser device 11 as the laser light L.

### 2.5 Modification of Solid-State Laser Device

### 2.5.1 Configuration and Operation

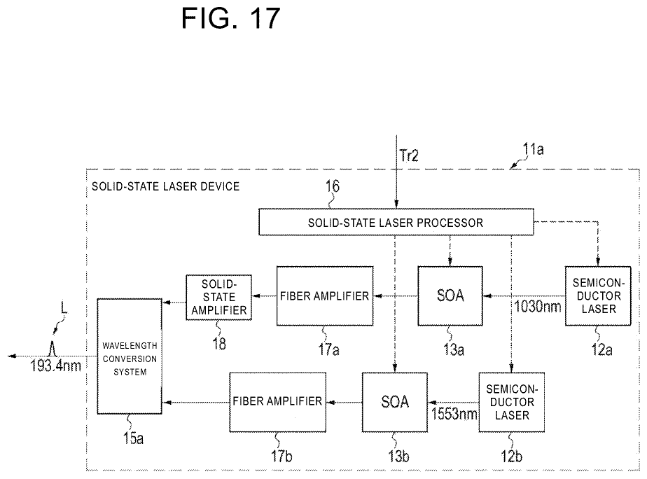

FIG. 17 schematically shows the configuration of a solid-state laser device 11a according to a modification of the first embodiment. The solid-state laser device 11a includes a semiconductor laser 12a, an SOA 13a, a fiber amplifier 17a, a solid-state amplifier 18, a semiconductor laser 12b, an SOA 13b, a fiber amplifier 17b, a wavelength conversion system 15a, and the solid-state laser processor 16.

Upon receiving the second internal trigger signal Tr2 from the laser processor 50, the solid-state laser processor 16 outputs a trigger signal to the semiconductor laser 12a and the semiconductor laser 12b. Upon receiving the trigger signal from the solid-state laser processor 16, the semiconductor laser 12a outputs continuously oscillating laser light having a wavelength in the vicinity of 1030 nm. Upon receiving the trigger signal from the solid-state laser processor 16, the semiconductor laser 12b outputs continuously oscillating laser light having a wavelength in the vicinity of 1553 nm.

Upon receiving a control signal from the solid-state laser processor 16, the SOA 13a amplifies the laser light output from the semiconductor laser 12a only for a predetermined period of time, thereby outputting laser light having a predetermined pulse width. Upon receiving a control signal from the solid-state laser processor 16, the SOA 13b amplifies the laser light output from the semiconductor laser 12b only for a predetermined period of time, thereby outputting laser light having a predetermined pulse width. The pulse width of the laser light output from each of the SOA 13a and the SOA 13b is within a range of 100 ps to 1 ns both inclusive.

The fiber amplifier 17a amplifies the laser light output from the SOA 13a and outputs the amplified laser light. The fiber amplifier 17b amplifies the laser light output from the SOA 13b and outputs the amplified laser light. Here, a plurality of the fiber amplifiers 17a may be arranged at a stage subsequent to the SOA 13a. Similarly, a plurality of the fiber amplifiers 17b may be arranged at a stage subsequent to the SOA 13b.

The solid-state amplifier 18 amplifies the laser light output from the fiber amplifier 17a. The solid-state amplifier 18 includes a crystal doped with Yb or a ceramic. The solid-state amplifier 18 is, for example, a Yb:YAG solid-state amplifier. Here, the number of the solid-state amplifiers 18 is not limited to one, and a plurality of the solid-state amplifiers 18 may be arranged at a stage subsequent to the fiber amplifier 17a.

The wavelength conversion system 15a includes an LBO crystal and three CLBO crystals (CLBO1, CLBO2, CLBO3). The LBO crystal converts the laser light having a wavelength of 1030 nm output from the solid-state amplifier 18 into laser light having a wavelength of 515 nm which is the second harmonic. The CLBO1 converts the laser light having a wavelength of 515 nm output from the LBO crystal into laser light having a wavelength of 257.5 nm which is the second harmonic. The CLBO2 generates laser light having a wavelength of 220.9 nm, which is sum frequency light of the laser light having a wavelength of 257.5 nm output from the CLBO1 and the laser light having a wavelength of 1553 nm output from the fiber amplifier 17b. The CLBO3 generates laser light having a wavelength of 193.4 nm, which is sum frequency light of the laser light having a wavelength of 220.9 nm output from the CLBO2 and the laser light having a wavelength of 1553 nm transmitted through the CLBO2. The laser light wavelength-converted by the wavelength conversion system 15a is output from the solid-state laser device 11 as the laser light L.

### 3. Second Embodiment

Next, the laser processing system according to a second embodiment will be described. Any component same as that described above is denoted by an identical reference sign, and duplicate description thereof is omitted unless specific description is needed.

### 3.1 Configuration and Operation

The laser processing system according to the second embodiment is different from the laser processing system according to the first embodiment only in the configuration of the laser device. Hereinafter, differences from the configuration of the laser device 2a according to the first embodiment will be described.

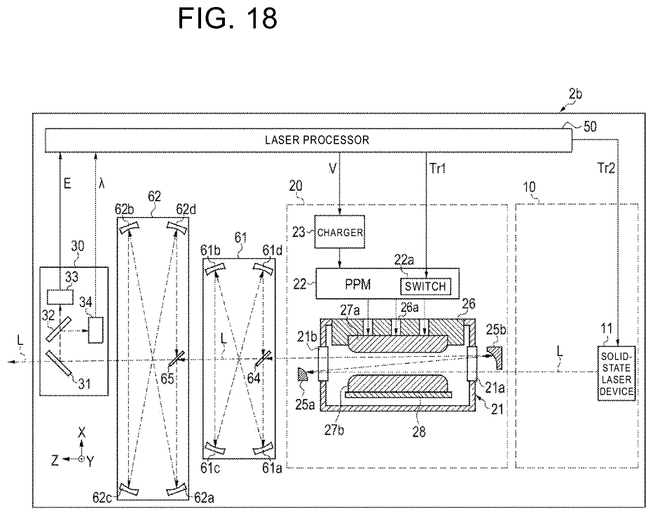

FIG. 18 schematically shows the configuration of a laser device 2b according to the second embodiment. The laser device 2b is different from the laser device 2a according to the first embodiment only in that, as in the comparative example, the solid-state oscillator 10 does not include the third OPS 63. That is, in the present embodiment, the laser light Lis burst-pulsed by the first OPS 61 and the second OPS 62 arranged at a stage subsequent to the ArF excimer amplifier 20.

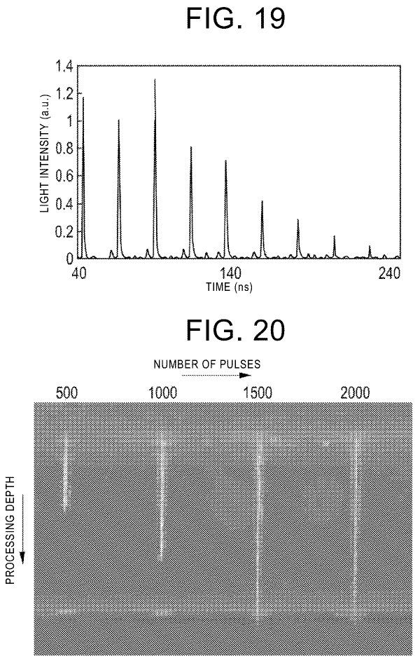

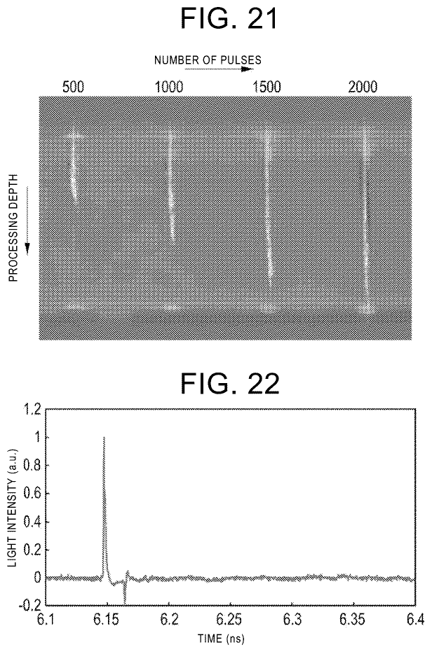

FIG. 19 shows an example of a waveform of the burst-pulsed laser light L output from the laser device 2b according to the second embodiment. FIG. 20 shows a result of drilling performed by the laser processing system according to the second embodiment. FIG. 21 shows a result of drilling performed by the laser processing system according to the first embodiment. In both experiments, the same light concentrating optical system 48 was used, and drilling was performed with the same input energy.

As shown in FIG. 19, in the second embodiment, the number of burst pulses is smaller than that in the first embodiment shown in FIG. 8. However, according to FIGS. 20 and 21, in the second embodiment, although the number of burst pulses is decreased, it can be understood that drilling can be performed at substantially the same processing rate as in the first embodiment.

Next, the result of drilling performed by the laser processing system 1 according to the comparative example is shown. FIG. 22 shows an example of a waveform of the single pulse laser light L output from the laser device 2 according to the comparative example. FIG. 23 shows a result of drilling performed in the comparative example with the beam waist position being shifted, where the input energy of the laser light Lis 0.2 mJ, the repetition frequency is 1 kHz, and the number of pulses is 1000. As shown in FIG. 23, in the comparative example, cracks occur even when the beam waist position is adjusted, and it can be understood that the processing quality is low.

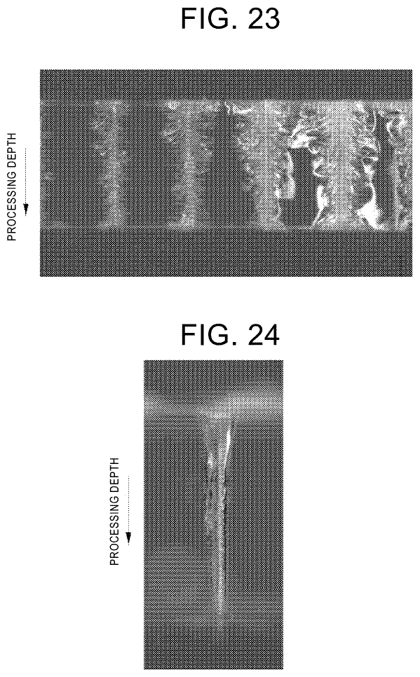

FIG. 24 shows a result of drilling performed in the second embodiment, where the input energy of the laser light Lis 1.1 mJ, the repetition frequency is 1 kHz, and the number of pulses is 1000. As shown in FIG. 24, in the second embodiment, compared with the case of the comparative example shown in FIG. 23, cracks do not occur even when the input energy is 5 times higher, and it can be understood that the processing quality is improved. It is considered that this is because the next pulse is radiated before a product generated by radiation of a pulse is re-fixed, and thus stress on the workpiece 45 due to re-fixing is suppressed.

### 3.2 Effect

Since the laser device 2b according to the second embodiment does not include the third OPS 63, the configuration can be simplified as compared with the first embodiment. In the second embodiment, processing can be performed at the same processing rate as in the first embodiment. Further, in the second embodiment, by performing processing with burst pulses, as in the first embodiment, the threshold value at which damage such as cracks occurs is increased, and the processing quality is improved.

### 4. Third Embodiment

Next, the laser processing system according to a third embodiment will be described. Any component same as that described above is denoted by an identical reference sign, and duplicate description thereof is omitted unless specific description is needed.

### 4.1 Configuration and Operation

The laser processing system according to the third embodiment is different from the laser processing system according to the first embodiment only in the configuration of the laser device. Hereinafter, differences from the configuration of the laser device 2a according to the first embodiment will be described.

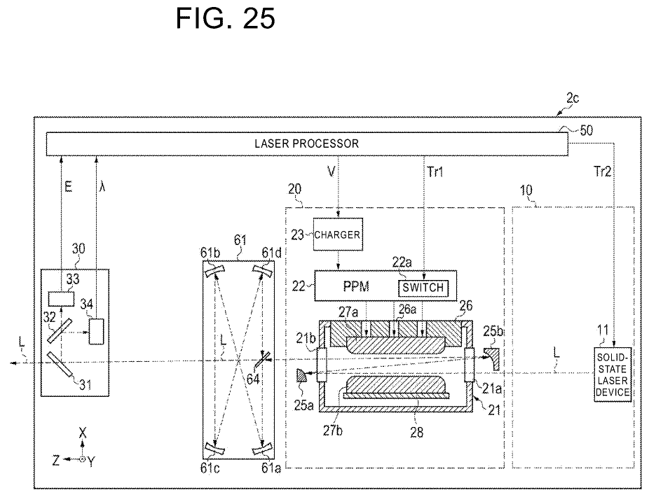

FIG. 25 schematically shows the configuration of a laser device 2c according to the third embodiment. The laser device 2c is different from the laser device 2a according to the first embodiment in that the solid-state oscillator 10 does not include the second OPS 62 as well as the third OPS 63. That is, in the present embodiment, the laser light L is burst-pulsed by the first OPS 61 arranged at a stage subsequent to the ArF excimer amplifier 20.

### 4.2 Effect

Since the laser device 2c according to the third embodiment does not include the second OPS 62 and the third OPS 63, the configuration can be simplified as compared with the second embodiment. Further, in the third embodiment as well, the same effects as in the first embodiment can be obtained.

### 5. Fourth Embodiment

Next, the laser processing system according to a fourth embodiment will be described. Any component same as that described above is denoted by an identical reference sign, and duplicate description thereof is omitted unless specific description is needed.

### 5.1 Configuration and Operation

The laser processing system according to the fourth embodiment is different from the laser processing system according to the first embodiment only in the configuration of the laser device. Hereinafter, differences from the configuration of the laser device 2a according to the first embodiment will be described.

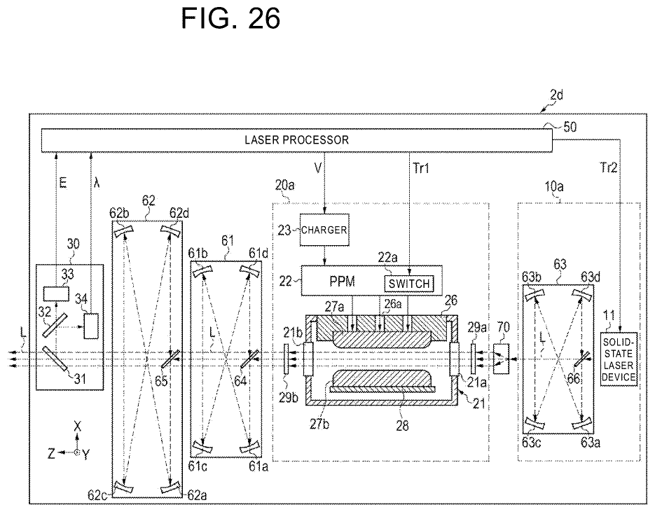

FIG. 26 schematically shows the configuration of a laser device 2d according to the fourth embodiment. The laser device 2d is different from the laser device 2a according to the first embodiment in that an ArF excimer amplifier 20a having an optical resonator is included as a power oscillator in place of a multipass amplifier. Specifically, the ArF excimer amplifier 20a has a Fabry-Perot optical resonator configured of a rear mirror 29a and an output coupling mirror 29b in place of the convex mirror 25a and the concave mirror 25b. The rear mirror 29a is, for example, a partial reflection mirror having a reflectance in a range of 50% to 90% both inclusive. The output coupling mirror 29b is, for example, a partial reflection mirror having a reflectance in a range of 10% to 30% both inclusive.

The laser device 2d is different from the laser device 2a according to the first embodiment in that a beam expander 70 is included between the solid-state oscillator 10a and the ArF excimer amplifier 20a. The beam expander 70 expands the beam size of the laser light output from the solid-state oscillator 10a such that the beam size matches the size of the discharge space of the ArF excimer amplifier 20a.

The laser light L expanded by the beam expander 70 is transmitted through the rear mirror 29a and is amplified by the optical resonator. The laser light L amplified by the optical resonator is output from the output coupling mirror 29b.

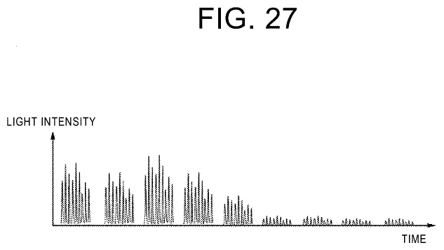

FIG. 27 shows an example of a waveform of the burst-pulsed laser light L output from the laser device 2d according to the fourth embodiment. Since the ArF excimer amplifier 20a has the optical resonator, the number of pulses of the burst pulses output from the laser device 2d is larger than that in the first embodiment.

### 5.2 Effect

In the laser device 2d according to the fourth embodiment, the number of pulses of the burst pulses can be increased as compared with the first embodiment, and thus the generation amount of ozone can be suppressed. In the fourth embodiment as well, the same effects as in the first embodiment can be obtained.

Here, the optical resonator included in the ArF excimer amplifier 20a is not limited to a Fabry-Perot optical resonator, and may be a ring resonator. Further, instead of arranging the beam expander 70, a slit having a size of 0.7 times to 2 times the beam size of the laser light L output from the solid-state oscillator 10a may be arranged in the ArF excimer amplifier 20a.

### 6. Modification of Solid-State Laser Device

In the first embodiment, the laser light Lis burst-pulsed by providing the third OPS 63 at a stage subsequent to the solid-state laser device 11. Hereinafter, a solid-state laser device capable of outputting the burst-pulsed laser light L without providing the third OPS 63 will be exemplified.

### 6.1 First Modification

### 6.1.1 Configuration and Operation

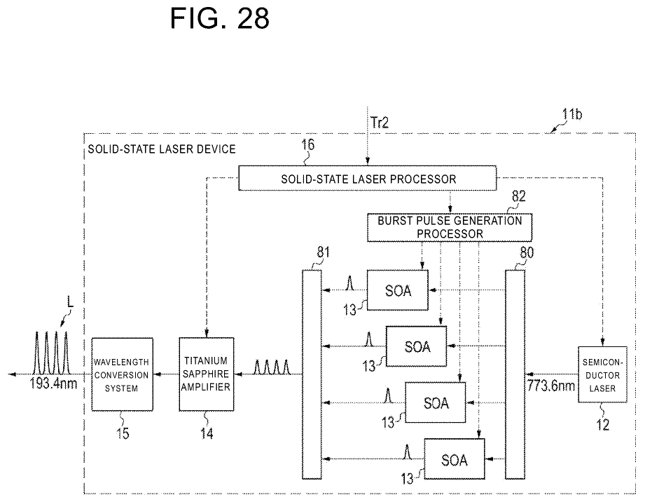

FIG. 28 schematically shows the configuration of a solid-state laser device 11b according to a first modification. The solid-state laser device 11b includes the semiconductor laser 12, a beam splitter 80, a plurality of the SOAs 13, a beam combiner 81, the titanium sapphire amplifier 14, the wavelength conversion system 15, a burst pulse generation processor 82, and the solid-state laser processor 16.

The plurality of SOAs 13 are connected in parallel between the beam splitter 80 and the beam combiner 81. In the present modification, four SOAs 13 are provided. Each of the beam splitter 80 and the beam combiner 81 are configured of a fiber coupler or the like.

Upon receiving the second internal trigger signal Tr2 from the laser processor 50, the solid-state laser processor 16 outputs a trigger signal to the semiconductor laser 12. Upon receiving the trigger signal from the solid-state laser processor 16, the semiconductor laser 12 outputs continuously oscillating laser light having a wavelength in the vicinity of 773.6 nm.

The beam splitter 80 splits the laser light output from the semiconductor laser 12 into a plurality of beams of laser light. The plurality of beams of laser light split by the beam splitter 80 enter the plurality of SOAs 13, respectively. Upon receiving the control signal from the burst pulse generation processor 82, each SOA 13 amplifies the laser light having entered from the beam splitter 80 only for a predetermined period of time, thereby outputting laser light having a predetermined pulse width.

The burst pulse generation processor 82 causes the laser light output from the beam combiner 81 to be burst-pulsed by shifting the timing at which the laser light is pulsed in each of the plurality of SOAs 13. The shift time of the pulsed timing is, for example, within a range of 2 ns to 4 ns both inclusive. That is, the interval between a plurality of pulses included in the burst pulses is 2 ns or more and 4 ns or less.

The beam combiner 81 combines the plurality of beams of the laser light output from the plurality of SOAs 13 with the output timings shifted from each other, and outputs the burst-pulsed laser light.

The titanium sapphire amplifier 14 amplifies the laser light output from the beam combiner 81 and outputs the amplified laser light. The wavelength conversion system 15 performs wavelength conversion on the laser light output from the titanium sapphire amplifier 14. Specifically, the wavelength conversion system 15 converts the laser light having a wavelength of 773.6 nm output from the titanium sapphire amplifier 14 into laser light having a wavelength of 193.4 nm which is the fourth harmonic. The laser light wavelength-converted by the wavelength conversion system 15 is output from the solid-state laser device 11b as the burst-pulsed laser light L.

### 6.1.2 Effect

In the solid-state laser device 11b according to the present modification, the number of pulses and the intensity of the burst pulses can be arbitrarily set. Therefore, in the present modification, as in the first embodiment, the number of pulses of the burst pulses can be increased as compared with the case in which burst pulsing is performed using the third OPS 63, and the generation amount of ozone can be further suppressed.

### 6.2 Second Modification

### 6.2.1 Configuration and Operation

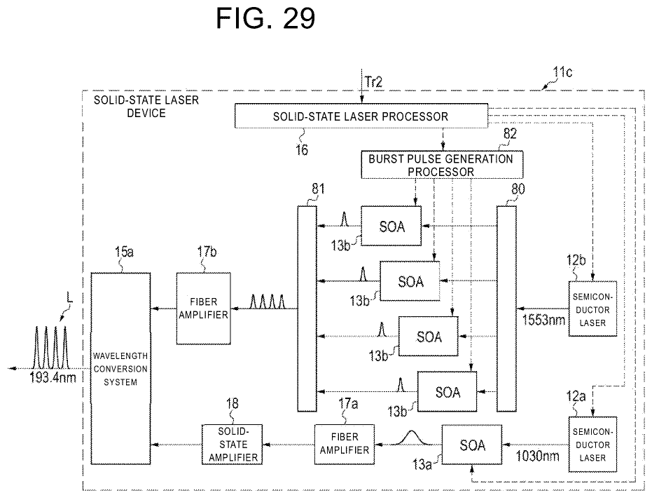

FIG. 29 schematically shows the configuration of a solid-state laser device 11c according to a second modification. The solid-state laser device 11c includes the semiconductor laser 12a, the SOA 13a, the fiber amplifier 17a, the solid-state amplifier 18, the semiconductor laser 12b, the beam splitter 80, a plurality of the SOAs 13b, the beam combiner 81, the fiber amplifier 17b, the wavelength conversion system 15a, the burst pulse generation processor 82, and the solid-state laser processor 16.

The semiconductor laser 12a corresponds to the “first semiconductor laser” according to the technology of the present disclosure. The semiconductor laser 12b corresponds to the “second semiconductor laser” according to the technology of the present disclosure. The SOA 13a corresponds to the “first semiconductor optical amplifier” according to the technology of the present disclosure. The SOA 13b corresponds to the “second semiconductor optical amplifier” according to the technology of the present disclosure. The fiber amplifier 17a corresponds to the “first fiber amplifier” according to the technology of the present disclosure. The fiber amplifier 17b corresponds to the “second fiber amplifier” according to the technology of the present disclosure.

Upon receiving the second internal trigger signal Tr2 from the laser processor 50, the solid-state laser processor 16 outputs a trigger signal to the semiconductor laser 12a and the semiconductor laser 12b. Upon receiving the trigger signal from the solid-state laser processor 16, the semiconductor laser 12a outputs continuously oscillating laser light having a wavelength in the vicinity of 1030 nm. Upon receiving the trigger signal from the solid-state laser processor 16, the semiconductor laser 12b outputs continuously oscillating laser light having a wavelength in the vicinity of 1553 nm.

The plurality of SOAs 13b are connected in parallel between the beam splitter 80 and the beam combiner 81. In the present modification, the number of SOAs 13b is four.

The SOA 13a, the fiber amplifier 17a, and the solid-state amplifier 18 have the same configurations as the SOA 13a, the fiber amplifier 17a, and the solid-state amplifier 18 included in the solid-state laser device 11a shown in FIG. 17, respectively. The amplified single pulse laser light is output from the solid-state amplifier 18.

The beam splitter 80, the plurality of SOAs 13b, and the beam combiner 81 have the same configurations as the beam splitter 80, the plurality of SOAs 13, and the beam combiner 81 included in the solid-state laser device 11b shown in FIG. 28, respectively. The burst-pulsed laser light is output from the beam splitter 80. The fiber amplifier 17b amplifies the laser light output from the beam combiner 81 and outputs the amplified laser light.

The wavelength conversion system 15a has the same configuration as the wavelength conversion system 15a shown in FIG. 17. The wavelength conversion system 15a generates laser light having a wavelength of 193.4 nm by performing wavelength conversion on the single pulse laser light output from the solid-state amplifier 18 and the burst-pulsed laser light output from the fiber amplifier 17b. The laser light wavelength-converted by the wavelength conversion system 15a is output from the solid-state laser device 11c as the burst-pulsed laser light L.

Here, the burst pulse generation processor 82 shifts the timing at which the laser light is pulsed in each of the plurality of SOAs 13b. The shift time of the pulsed timing is, for example, within a range of 2 ns to 4 ns both inclusive. That is, the interval between a plurality of pulses included in the burst pulses is 2 ns or more and 4 ns or less.

The solid-state laser processor 16 controls the SOA 13a so that the single pulse and the burst pulses temporally overlap with each other in the wavelength conversion system 15a, and sets the pulse width of the single pulse longer than the time width in which all pulses of the burst pulses are included.

### 6.2.2 Effect

In the solid-state laser device 11c according to the present modification, the number of pulses and the intensity of the burst pulses can be arbitrarily set. Therefore, in the present modification, as in the first embodiment, the number of pulses of the burst pulses can be increased as compared with the case in which burst-pulsing is performed using the third OPS 63, and the generation amount of ozone can be further suppressed.

The description above is intended to be illustrative and the present disclosure is not limited thereto. Therefore, it would be obvious to those skilled in the art that various modifications to the embodiments of the present disclosure would be possible without departing from the spirit and the scope of the appended claims.

The terms used throughout the present specification and the appended claims should be interpreted as non-limiting terms. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C as well as to include combinations of the any thereof and any other than A, B, and C.

What is claimed is:

1. A laser device to be used in a laser processing system for performing laser processing by irradiating a workpiece with laser light in a gas containing oxygen, the laser device comprising:
a solid-state oscillator including a solid-state laser device configured to output laser light having a pulse width in a range of 100 ps to 1 ns both inclusive and having a center wavelength within an oscillation wavelength range of an ArF excimer laser device and outside absorption lines of oxygen;
an ArF excimer amplifier configured to amplify the laser light output from the solid-state oscillator; and
a first optical pulse stretcher configured to output laser light that is burst-pulsed by dividing the laser light amplified by the ArF excimer amplifier into a plurality of pulses as the laser light being caused to circulate through a delay optical path thereof.

2. The laser device according to claim 1,
wherein the oscillation wavelength range of the ArF excimer laser device is a wavelength range of 193.0 nm or more and 193.9 nm or less.

3. The laser device according to claim 1,
wherein the center wavelength is a wavelength included in a wavelength range of 193.113 nm or more and 193.273 nm or less, a wavelength range of 193.292 nm or more and 193.472 nm or less, or a wavelength range of 193.493 nm or more and 193.697 nm or less.

4. The laser device according to claim 1,
wherein the center wavelength is a wavelength included in a wavelength range of 193.12 nm or more and 193.26 nm or less, a wavelength range of 193.30 nm or more and 193.46 nm or less, or a wavelength range of 193.50 nm or more and 193.68 nm or less.

5. The laser device according to claim 1,
wherein a delay time of the laser light due to the delay optical path of the first optical pulse stretcher is in a range of 2 times to 500 times both inclusive of the pulse width.

6. The laser device according to claim 1,
wherein an optical path length of the delay optical path of the first optical pulse stretcher is in a range of 2 meters to 14 meters both inclusive.

7. The laser device according to claim 1, further comprising:
a second optical pulse stretcher configured to output laser light that is burst-pulsed by dividing the laser light output from the first optical pulse stretcher into a plurality of pulses as the laser light being caused to circulate through a delay optical path thereof.

8. The laser device according to claim 7,
wherein an optical path length of the delay optical path of the second optical pulse stretcher is longer than an optical path length of the delay optical path of the first optical pulse stretcher.

9. The laser device according to claim 8,
wherein the optical path length of the delay optical path of the second optical pulse stretcher is in a range of 1.5 times to 3 times both inclusive of the optical path length of the delay optical path of the first optical pulse stretcher.

10. The laser device according to claim 7,
wherein the solid-state oscillator includes a third optical pulse stretcher configured to output laser light that is burst-pulsed by dividing the laser light output from the solid-state laser device into a plurality of pulses as the laser light being caused to circulate through a delay optical path thereof.

11. The laser device according to claim 10,
wherein an optical path length of the delay optical path of the third optical pulse stretcher is shorter than an optical path length of the delay optical path of the first optical pulse stretcher.

12. The laser device according to claim 10,
wherein an optical path length of the delay optical path of the third optical pulse stretcher is in a range of 0.6 meter to 1.4 meter both inclusive.

13. The laser device according to claim 10,
wherein the ArF excimer amplifier includes an optical resonator.

14. The laser device according to claim 1,
wherein the ArF excimer amplifier is a multipass amplifier.

15. The laser device according to claim 1,
wherein the solid-state laser device includes:
a semiconductor laser configured to output continuously oscillating laser light;
a beam splitter configured to split the laser light output from the semiconductor laser into a plurality of beams of laser light;
a plurality of semiconductor optical amplifiers configured to perform pulsing on the plurality of beams of laser light output from the beam splitter;
a beam combiner configured to combine the plurality of beams of laser light output from the plurality of semiconductor optical amplifiers;
a burst pulse generation processor configured to cause laser light output from the beam combiner to be burst-pulsed by shifting a timing at which the laser light is pulsed in each of the semiconductor optical amplifiers;
a titanium sapphire amplifier configured to amplify the laser light output from the beam combiner; and
a wavelength conversion system configured to output the burst-pulsed laser light in the oscillation wavelength range of the ArF excimer laser device by performing wavelength conversion on the laser light output from the titanium sapphire amplifier.

16. The laser device according to claim 15,
wherein an interval between a plurality of pulses included in the burst pulses is 2 ns or more and 4 ns or less.

17. The laser device according to claim 1,
wherein the solid-state laser device includes:
a first semiconductor laser configured to output continuously oscillating laser light;
a first semiconductor optical amplifier configured to perform pulsing on the laser light output from the first semiconductor laser;
a first fiber amplifier configured to amplify the laser light output from the first semiconductor optical amplifier,
a solid-state amplifier configured to amplify the laser light output from the first fiber amplifier;
a second semiconductor laser configured to output continuously oscillating laser light;
a beam splitter configured to split the laser light output from the second semiconductor laser into a plurality of beams of laser light;
a plurality of second semiconductor optical amplifiers configured to perform pulsing on the plurality of beams of laser light output from the beam splitter;
a beam combiner configured to combine the plurality of beams of laser light output from the plurality of second semiconductor optical amplifiers;
a burst pulse generation processor configured to cause the laser light output from the beam combiner to be burst-pulsed by shifting a timing at which the laser light is pulsed in each of the second semiconductor optical amplifiers;
a second fiber amplifier configured to amplify the laser light output from the beam combiner; and
a wavelength conversion system configured to output the burst-pulsed laser light in the oscillation wavelength range of the ArF excimer laser device by performing wavelength conversion on the laser light output from the solid-state amplifier and the laser light output from the second fiber amplifier.

18. The laser device according to claim 17,
wherein an interval between a plurality of pulses included in the burst pulses is 2 ns or more and 4 ns or less.

19. A laser processing system for performing laser processing by irradiating a workpiece with laser light in a gas containing oxygen, the laser processing system comprising:
a laser device; and
an optical device configured to irradiate the workpiece with burst-pulsed laser light output from the laser device,
the laser device including:
a solid-state oscillator including a solid-state laser device configured to output laser light having a pulse width in a range of 100 ps to 1 ns both inclusive and having a center wavelength within an oscillation wavelength range of an ArF excimer laser device and outside absorption lines of oxygen;
an ArF excimer amplifier configured to amplify the laser light output from the solid-state oscillator; and
a first optical pulse stretcher configured to output laser light that is burst-pulsed by dividing the laser light amplified by the ArF excimer amplifier into a plurality of pulses as the laser light being caused to circulate through a delay optical path thereof.

20. A laser processing method for performing laser processing by irradiating a workpiece with laser light in a gas containing oxygen, the laser processing method comprising:
performing laser processing by irradiating the workpiece with burst-pulsed laser light generated by a laser device,
the laser device including:
a solid-state oscillator including a solid-state laser device configured to output laser light having a pulse width in a range of 100 ps to 1 ns both inclusive and having a center wavelength within an oscillation wavelength range of an ArF excimer laser device and outside absorption lines of oxygen;
an ArF excimer amplifier configured to amplify the laser light output from the solid-state oscillator; and
a first optical pulse stretcher configured to output laser light that is burst-pulsed by dividing the laser light amplified by the ArF excimer amplifier into a plurality of pulses as the laser light being caused to circulate through a delay optical path thereof.
